(19) United States
(12) Patent Application Publication
(10) Pub. No.: US 2013/0001371 A1
(43) Pub. Date: Jan. 3, 2013

(54) HOLDER

(75) Inventor: Kazutoshi Hamamoto, Tokyo (JP)

(73) Assignee: MITSUBISHI HEAVY INDUSTRIES, LTD., Tokyo (JP)

(21) Appl. No.: 13/537,710

(22) Filed: Jun. 29, 2012

(30) Foreign Application Priority Data
Jun. 30, 2011 (JP) 2011-146527

(51) Int. Cl. F16L 3/00

(52) U.S. Cl. 248/56

(57) ABSTRACT

A holder includes a first block having a stopper and a first restrained section and being made from the material which have the insulating property; a second block having a second restrained section and being made from the material which have the insulating property; and a restraining member, wherein the fixed member is surrounded to be sandwiched using the first block and the second block, the first and the second blocks are inserted into a through hole of the base member until the stopper comes in contact with the base member and the blocks are prevented from entering, and the first restrained section and the second restrained section protruding from the through hole are restrained by the restraining member so that the fixed member is fixed to the base member.

### BACKGROUND OF THE INVENTION

1. Field of the Invention

The present invention relates to a holder and particularly, to a holder which fixes a fixed member to a base member including the through hole through which the fixed member is arranged.

2. Description of Related Art

As a member including a through hole (a base member), for example, as shown in FIG. 7, an H-shaped steel (also, referred to as an “H steel” or an “H-shaped steel”) 2 is exemplified in which a substantially rectangular through hole 1 of the dimensions “H1”×“H2” is provided in an steel having a thickness dimension “H3”. In FIG. 7, the through hole 1 is not formed in flanges of the H-shaped steel, but in a web connecting the flanges at an intermediate position thereof. A distance between the flanges is a dimension “H4”.

In FIG. 7, in order to provide electric equipment inside a freight container, a plurality of similar H-shaped steels 2 are appropriately arranged and fixed at a floor (not shown) of the freight container at a predetermined distance, and furthermore, a plate-shaped wiring 3 (corresponding to a fixed member) is arranged through each of the through holes 1 of a plurality of H-shaped steels 2 to supply the electric power to the electric equipment.

For example, the plate-shaped wiring 3 is a substantially rectangular copper plate having the dimensions “M1”×“M2” in a cross section thereof (here, “M1”<“H1” and “M2”<“H2”<“H4”). Thus, in order to electrically insulate the plate-shaped wiring 3 and the H-shaped steel 2, in other words, not to come in contact with each other, the plate-shaped wiring 3 and the H-shaped steel 2 are appropriately arranged and then the plate-shaped wiring 3 is fixed to the floor by insulators 4.

Thus, in order to obtain a good insulating relation between the plate-shaped wiring 1 and the H-shaped steel 2, a solution is considered in that when appropriately arranging the plate-shaped wiring 1, the plate-shaped wiring 1 is sandwiched by a holder (see Japanese Unexamined Utility Model Application Publication No. 63-127235) formed of insulating resin or the like and then the holder is arranged inside the through hole 1.

However, in the configuration shown in FIG. 7, the holder, which is simply located inside the through hole 1 to sandwich the plate-shaped wiring 3, may deviate to outside the through hole 1 and, in some cases, the holder may deviate from the plate-shaped wiring 3 due to oscillation or vibration when the freight container is moved. In this case, even though the plate-shaped wiring 3 is fixed to the floor by the insulators 4, there is a concern that the plate-shaped wiring 3 be warped by the oscillation or the vibration and thereby the plate-shaped wiring 3 and the H-shaped steel 2 may be electrically connected.

In addition, one plate-shaped wiring 3, arranged in a state of being passed through the through hole 1 of the H-shaped steel 2, is fixed to the floor to be supported by a plurality of the insulators 4, so that there is a concern that the amount of work and cost thereof may increase.

Thus, an object of the invention is to provide an holder where the number of supporting members such as the insulators 4 can be decreased by reliably fixing the fixed member such as the plate-shaped wiring 1 to a predetermined position of the through hole of the base member, wherein the holder is also easily removable.

### SUMMARY OF THE INVENTION

According to an aspect of the invention, there is provided a holder which includes a first block having a stopper and a first restrained section and being made from the material which have the insulating property; a second block having a second restrained section and being made from the material which have the insulating property; and a restraining member, wherein a fixed member is surrounded to be sandwiched by using the first block and the second block, the first and the second blocks are inserted into a through hole of a base member until the stopper comes into contact with the base member and the blocks are prevented from entering, and the first restrained section and the second restrained section protruding from the through hole are restrained by the restraining member in order that the fixed member is fixed to the base member.

In other words, the holder of the invention surrounds the fixed member to sandwich the fixed member by using at least the first block and the second block, the first block and the second block are inserted into the through hole of the base member until stopped by the stopper, and the first block and the second block protruding through the through hole are restrained by the restraining member.

Accordingly, the fixed member can be reliably fixed to the base member in a state where the fixed member is surrounded to be sandwiched, so that insulation can be reliably performed between the base member and the fixed member. In addition, because the holder itself becomes a supporting member which supports the fixed member, the number of other supporting members can be decreased. Furthermore, when the restriction of the restraining member is undone, the fixed member can be disassembled quickly, because the holder can be easily removed. Also, improvement of the workability and decrease of the cost can be achieved from the viewpoint of maintenance.

According to the invention, the holder can be provided in which the fixed member can be reliably fixed to and easily removed from a predetermined position of the through hole of the base member.

### BRIEF DESCRIPTION OF THE DRAWINGS

FIGS. 1(a) and 1(b) are schematic views of a holder (configured of at least two blocks and a restraining member) of an embodiment of the invention. FIG. 1(a) is a schematic front view (a XY plan view) in a state where a plate-shaped wiring 3 is surrounded by two blocks to be sandwiched, FIG. 1(b) is a schematic front view (a XY plan view) of one block.

FIGS. 2(a) to 2(d) are schematic views of the block shown in FIG. 1. FIG. 2(a) is a schematic front view (a XY plan view) corresponding to FIG. 1(b). FIG. 2(b) is a side view (a XZ plan view) taken across line A-A′ of FIG. 2(a). FIG. 2(c) is a cross-sectional view (a XZ plan view) taken across line B-B′ of FIG. 2(a). FIG. 2(d) is a side view (a XZ plan view) taken across line C-C′ of FIG. 2A.

FIGS. 3(a) to 3(d) are schematic views of the block of FIGS. 1(a) and 1(b) seen from another viewpoint. FIG. 3(a) is a schematic front view (a XY plan view) corresponding to FIG. 1(b). FIG. 3(b) is a side view (an YZ plan view) taken across line D-D′ of FIG. 3(a). FIG. 3(c) is a cross-sectional view (an YZ plan view) taken across line E-E′ of FIG. 3(a). FIG. 3(d) is a cross-sectional view (an YZ plan view) taken across line F-F′ of FIG. 3(a).

FIGS. 4(a) and 4(b) are perspective views of the block shown in FIGS. 1(a) to 3(d).

FIG. 5 is a view describing a procedure in which three blocks shown in FIGS. 1(a) to 4(b) are assembled and the plate-shaped wiring 3 is fixed in a through hole 1 (one of blocks becomes a restraining member).

FIG. 6 is a schematic view describing a case where a fixed member having a shape other than the plate-shaped wiring 3 is fixed to the base member using the blocks shown in FIGS. 1(a) to 5.

FIG. 7 is a perspective view showing a configuration as an example of the related art, in which the plate-shaped wiring 3 (corresponding to the fixed member) is arranged in the through hole of the H-shaped steel 2 (corresponding to the base member) which is provided with the through hole 1.

### DETAILED DESCRIPTION OF THE INVENTION

One of the characteristics of the holder according to an embodiment of the invention is that a “fixed member” such as a plate-shaped wiring 3 is surrounded by at least two blocks to be sandwiched, the two blocks are inserted into a through hole of a “base member” such as a H-shaped steel 2 and a restraining member which restrains the two blocks to come into contact with both of two restrained sections is arranged at the restrained section of two blocks protruding through the through hole. Hereinafter, detailed description is given with reference to drawings. In the drawings, in a case where a rectangular coordinate system using XYZ-axes is described, the rectangular coordinate system is identical in all drawings. In addition, the dimensions or the lengths “H1”, “H2”, “H3”, “H4”, “M1”, “M2”, “L” and “N” shown in the views are all real numbers greater than zero.

In addition, the insulating holder fixing the plate-shaped wiring to the H-shaped steel including the through hole is described as an example, however, the invention is not limited to the H-shaped steel, and the insulating holder of the invention may be applied to any one of the base members which include the through hole. In addition, the invention is not limited to the plate-shaped wiring and the insulating holder of the invention may be applied to any one of the fixed members which is fixed through the through hole.

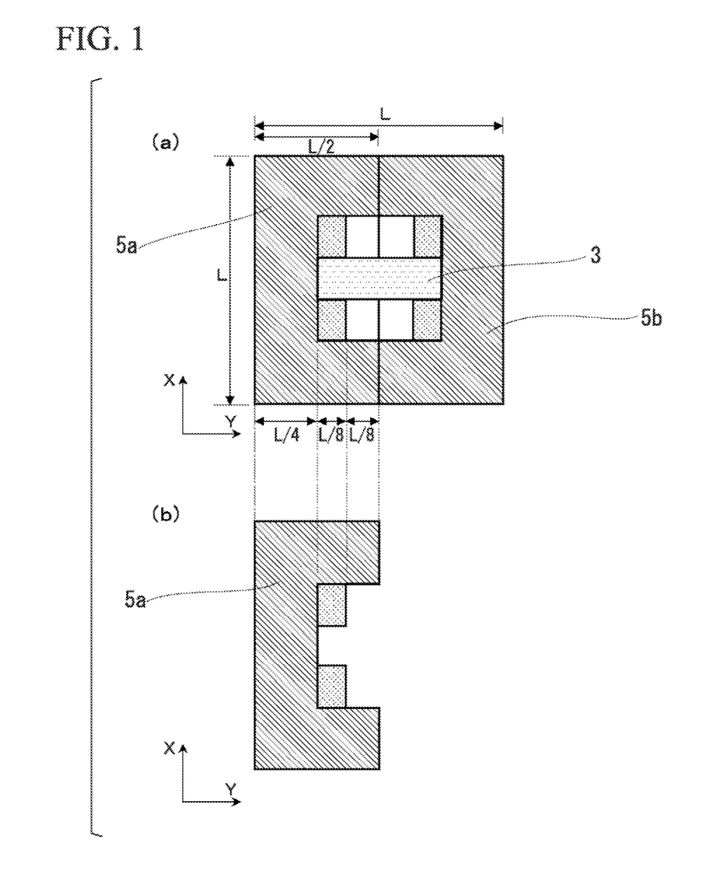

Hereinafter, the insulating holder 100 of the embodiment is described with reference to FIGS. 1(a) to 4(b). The insulating holder 100 of the embodiment is configured to include at least two blocks 5a and 5b having the same shape and a restraining member (here, a restraining section 6 is described as an example of the restraining member of a block 5c that has the same shape as the block 5a described below). In the embodiment, as an example, the blocks 5a, 5b and 5c all have the same shape and the same dimensions, and thereby the shape of one block 5 is described using the block 5a representatively.

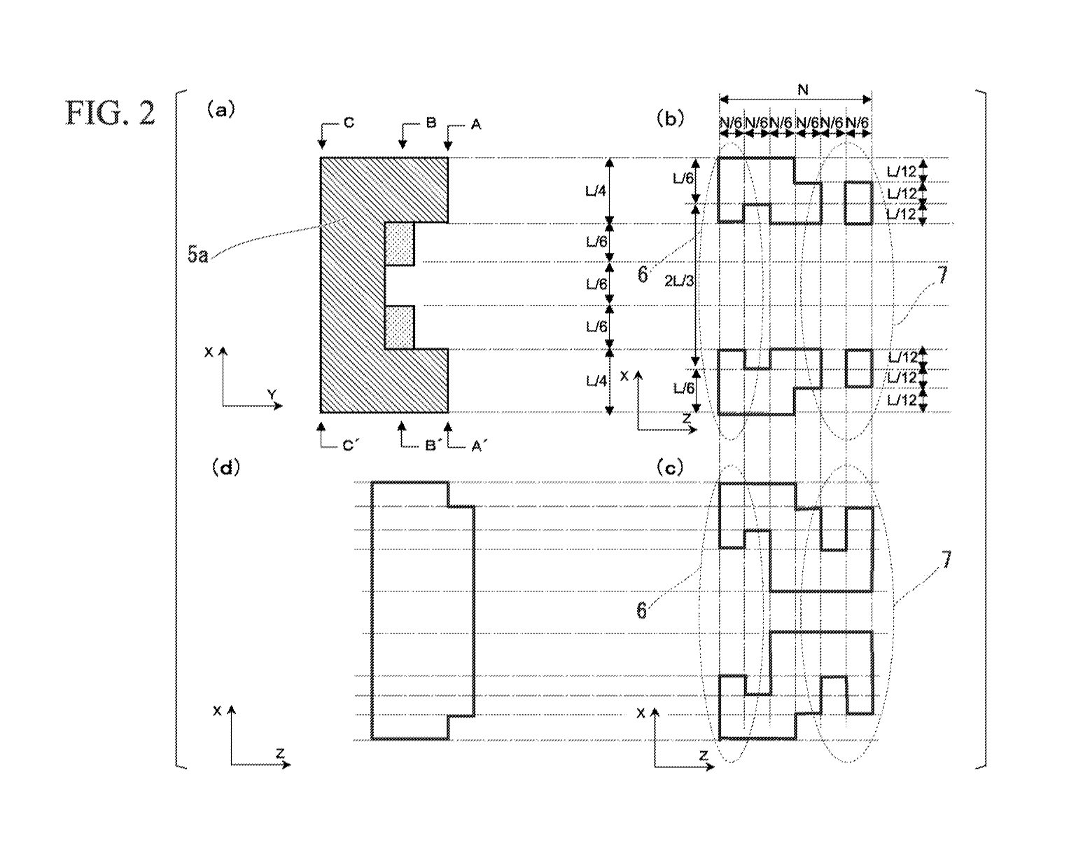

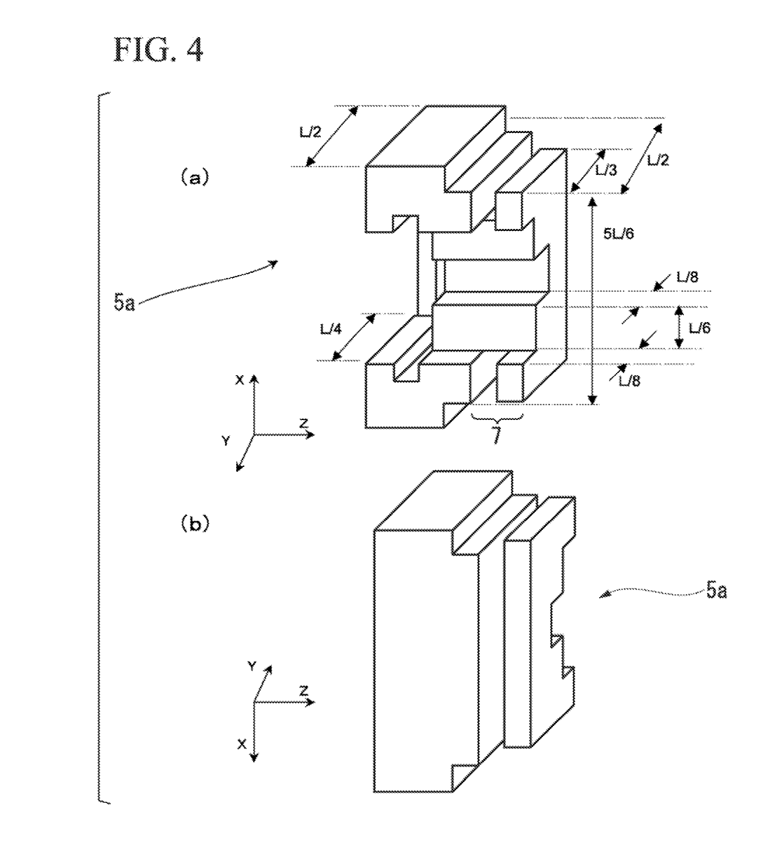

First, an outer shape of the block 5a is described. As shown in FIG. 1(b), when the block 5a is seen from the front surface which is on the XY-plane, the shape thereof is a substantial U-shape. In other words, specifically, three portions configuring a substantial U-shape are configured of one portion (first portion 10) extending in the X direction and two portions (second portions 11) connecting to ends of the first portion 10 respectively and extending to the +Y direction. The first portion 10 is substantially rectangular shape having a dimension “L” in the X direction and a dimension “L÷4” (in other words, “L/4”) in the Y direction. In addition, as shown in FIGS. 1(b) and 2(a), the second portions 11 are substantially rectangular shape having a dimension “L/4” in the X direction and a dimension “L/4” in the Y direction. An opening is formed at the block 5a by the U-shape configured of the first portion 10 and two second portions 11. Although the opening varies in size as advancing to the +Z direction of the block 5a, as shown in FIG. 4, the opening is uninterrupted from one end to the other end of the block 5a in Z direction.

Meanwhile, when the block 5a is seen from XZ-plane, as shown in FIGS. 2 and 4, the outer shape thereof has a substantially convex shape. In other words, when the dimension “N” from the front surface to the end in the +Z direction is used, the block 5a is configured of a portion (a third portion 12) having substantially rectangular shape of a dimension “L” in the X direction and a dimension “N÷2” (in other words, “N/2”) in the Z direction, and a portion (a fourth portion 13) which is located inside the third portion 12 in the X direction as much as a dimension “L÷12” (in other words, “N/12”) from the ends of the third portion 12 in the X direction respectively and connects to the third portion 12 from the end that is further in the +Y direction of two ends of the third portion 12 in the Y direction, and has a substantially rectangular shape of a dimension “L×(10÷12)” in the X direction and a dimension “N/2” in the Z direction.

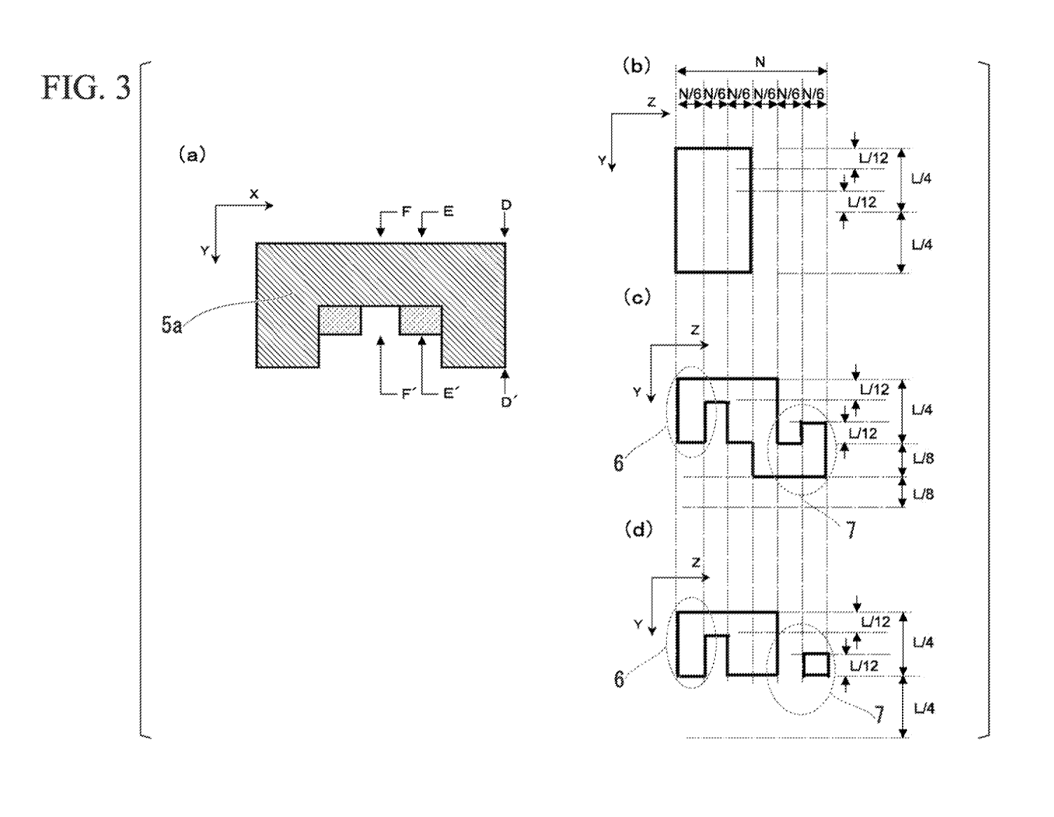

In addition, when the block 5a is seen from YZ-plane, as shown in FIGS. 3 and 4, the outer shape thereof is a substantially convex shape different from the substantial convex shape described above. In other words, the block 5a is configured of a portion (a fifth portion 14) having substantially rectangular shape of a dimension “L/2” in the Y direction and a dimension “N×(4÷6)” in Z direction, and a portion (a sixth portion 15) which connects from the end that is further in the +Y direction of two ends of the fifth portion 14 in the Y direction, and has a substantially rectangular shape of a dimension “L×(4÷12)” in the Y direction and a dimension “N×(2÷6)” in the Z direction.

The structure and the function of from the first portion 10 to the sixth portion 15 of the block 5a will now be described in detail.

As shown in FIG. 2(b) that is a side view (a XZ plan view) taken across line A-A′ of FIG. 2(a), in FIG. 2(c) that is a cross-sectional view (a XZ plan view) taken across line B-B′ of FIG. 2(a), in FIG. 3(c) that is a cross-sectional view (a YZ plan view) taken across line E-E′ of FIG. 3(a), and in FIG. 3(d) that is a cross-sectional view (a YZ plan view) taken across line F-F′ of FIG. 3(a), a groove (hereinafter, referred to as “a first groove”) is formed which has a width dimension “N/6” and a depth dimension “L/12” in the X direction when the groove is seen at the XZ-plane, and which is located from a position advanced as much as a dimension “N÷6” (in other words, “N/6”) from the front surface to the +Z direction. The groove has a width dimension “N/6 and a depth dimension “L×(2÷12)” in the Y direction when the groove is seen at the YZ-plane. Three-dimensional shape of the groove may be easily understood with reference to FIG. 4.

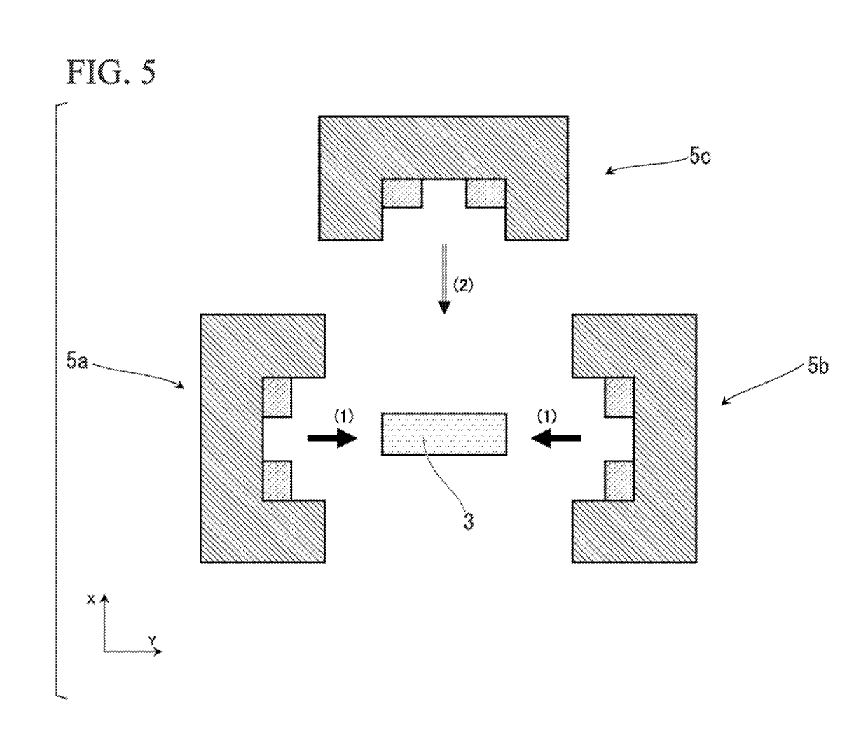

The first groove is formed in substantial U-shape at the surface inside the block 5a configured of from the first portion 10 to the third portion 12 and the fifth portion 14 and thereby the portion from the front surface to the dimension “N/6” to the +Z direction is a shape that relatively protrudes in a key shape. A portion (hereinafter, referred to as “a first protruding section”) of the shape that protrudes becomes the restraining section 6. The function or the like of the restraining section 6 is described below with reference to FIG. 5.

As shown in FIG. 2(b) that is a side view (a XZ plan view) taken across line A-A′ of FIG. 2(a), in FIG. 2(c) that is a cross-sectional view (a XZ plan view) taken across line B-B′ of FIG. 2(a), in FIG. 3(c) that is a cross-sectional view (a YZ plan view) taken across line E-E′ of FIG. 3(a), and in FIG. 3(d) that is a cross-sectional view (a YZ plan view) taken across line F-F′ of FIG. 3(a), a groove (hereinafter, referred to as “a second groove”) is formed which has a width dimension “N/6” in the Z direction from a position advanced as much as a dimension “N/6” to the −Z direction from a surface (hereinafter, referred to as “a rear surface”) present at opposite the front surface in the Z direction against the front surface in the Z direction. The depth of the groove is a depth of dimension “L×(3÷12)” in the X direction toward inside the block 5a from the outer shape when based on the outer shape of the third portion 12 in FIG. 2, and is a depth of dimension “L×(3÷12)” in the +Y direction from the outer shape when based on the outer shape of the fifth portion 14 in FIG. 3. Three-dimensional shape of the groove may be easily understood with reference to FIG. 4.

The second groove is formed in a substantial U-shape at the surface outside the block 5a configured of the first portion 10, second portion 11, fourth portion 13 and sixth portions 15 and thereby the portion from the rear surface to the dimension “N/6” in the −Z direction is a shape that relatively protrudes in a key shape. The portion (hereinafter, referred to as “a second protruding section”) of the shape that protrudes or the second groove is a restrained section 7. The function or the like of the restrained section 7 is described below with reference to FIG. 5.

As shown in FIGS. 2(c) and 3(c), the restraining section 6 and the restrained section 7 of the block 5a are connected to each other inside the block 5a. When seen from the front surface of FIG. 2(a), the connection described above is provided through two portions (two portions which are provided with hatching of points in FIG. 2(a)) which are substantially rectangular shaped having a dimension “L÷6” (in other words, “L/6”) in the X direction and a dimension “L÷8” (in other words, “L/8”) in the Y direction from a position advanced as much as a dimension “N×(2÷6)” to the +Z direction from the front surface. The distance between two portions is a dimension “L/6” in the X direction.

It is desirable for each of the portions of the block 5a having the shape described above to be integrally formed by a molding of insulating plastic resin, rubber or the like. Of course, if strength thereof can endure design specifications, even if the portions are not initially formed integrally, they may be adhered part-by-part, or the like, finally achieving the shape of the block 5a.

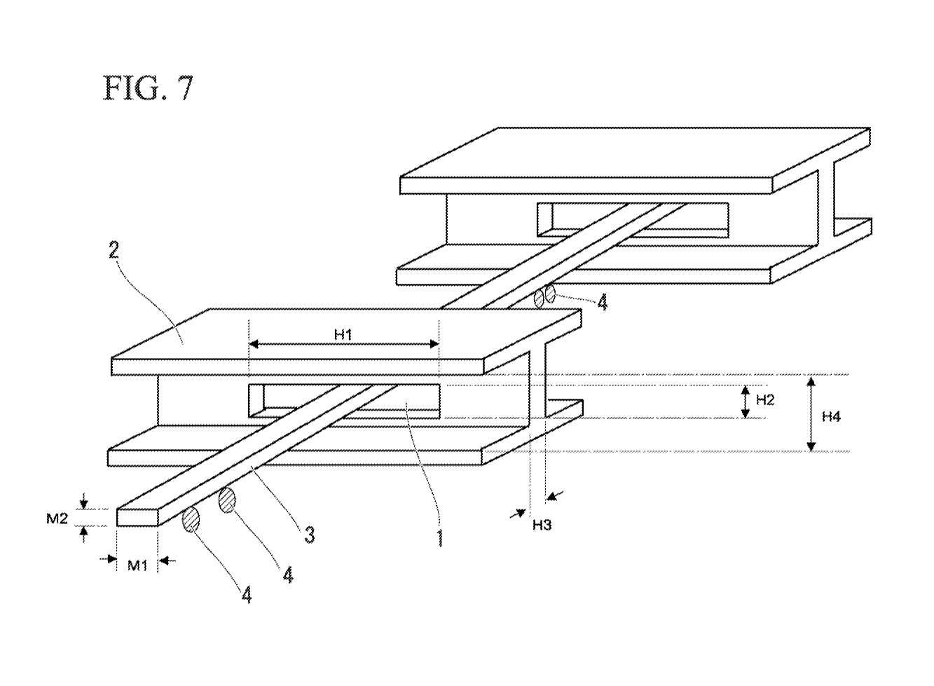

Using FIGS. 1(a), 1(b) and 5, a procedure is described in which the plate-shaped wiring 3 as the fixed member shown in FIG. 7 is fixed to the H-shaped steel 2 as the base member, using the above-described block 5a, and the block 5b and the block 5c which have the same material, the same dimensions and the same shapes as the block 5a.

Here, the dimension “M1” is substantially the same as the dimension “L/2”, the dimension “M2” is substantially the same as the dimension “L/6”, the dimension “H2” is substantially the same as the dimension “L×(10÷12)”, and the dimension “H3” is substantially the same as the dimension “N/6”. In addition, the dimension “H1” is the same as the dimension “L” or larger than the dimension “L”. However, the design is provided such that the value that is two times the dimension “L” is smaller than the dimension “H4”.

First, the plate-shaped wiring 3 is in a state of passing through the through hole 1 of the H-shaped steel 2. Thus, the block 5a and the block 5b that is in the same state as a state where the block 5a is rotated by 180° on the XY-plane are arranged near the through hole 1. Thus, as shown in the procedure (1) of FIG. 5, in a state where the plate-shaped wiring 3 is arranged at the openings of the block 5a and the block 5b respectively, the restraining section 6 and the restrained section 7 are in close contact with each other. Accordingly, as shown in FIG. 1(a), the plate-shaped wiring 3 adopts a surrounded state to be closely sandwiched between the above-described two portions of the two blocks 5a and 5b respectively.

Thus, in this state, the two blocks 5a and 5b are inserted into the through hole 1, and are pushed until the third portions 12 thereof come into contact with the H-shaped steel 2 and stop respectively. At this time, the third portions 12 function as stoppers to prevent the blocks 5a and 5b from advancing in the through hole 1 by catching on the H-shaped steel 2 so that the blocks 5a and 5b do not pass through the through hole 1.

After that, as shown in the procedure (2) of FIG. 5, the restraining section 6 of the block 5c that is in the same state as a state where the block 5a is rotated by 90° on the XY-plane is pushed to be inserted into the restrained section 7 of the two blocks 5a and 5b protruding from the through hole 1 respectively.

Accordingly, the H-shaped steel 2 is sandwiched by the front surface of the block 5c and the third portions 12 of the blocks 5a and 5b respectively, and furthermore the restraining section 6 of the block 5c is cleanly engaged in the restrained section 7 of the blocks 5a and 5b and thereby the blocks 5a and 5b are prevented from dropping out from the through hole 1. In other words, the function that the fixed member is reliably fixed to a predetermined position of the through hole of the base member including the through hole is achieved by the block 5a, block 5b, and a restraining member.

In addition, after the insulating holder 100 is assembled, the restraining section 6 of the block 5c can be easily removed by sliding the restraining section 6. Accordingly, since it is easy to undo the restriction and to disassemble the insulating holder 100, the function that the maintenance of the fixed member or the like is easily performed is also achieved.

In addition, a small concave portion or a convex portion is formed in the restrained sections 7 of the blocks 5a and 5b, a small convex portion or a concave portion which is engaged in the small concave portion and the convex portion described above is formed in the corresponding position of the restraining section 6 of the block 5c, and the restraining force may be enhanced when the restrained sections 7 of the blocks 5a and 5b are restrained at the restraining section 6 of the block 5c. Even in this case, the restraining section 6 of the block 5c can be easily removed from the restrained sections T of the blocks 5a and 5b.

In the above description, an example of the insulating holder 100 which uses three blocks 5a, 5b and 5c having the same dimensions and the same shapes as one set is described. In this way, when all blocks 5 have the same dimensions and the same shapes as each other, only one mold is formed and thereby the mold may be mass produced at low cost.

However, when at least two blocks 5a and 5b are used, the member that restrains the restrained sections 7 of the two blocks 5a and 5b do not need to be the block 5c. In other words, a restraining member having the same shape as the restraining section 6 of the block 5 is made separately and thereby the restrained sections 7 of the blocks 5a and 5b may be restrained simultaneously by the restraining member, or the restrained sections 7 of the blocks 5a and 5b may be restrained simultaneously by a string that is easily removed.

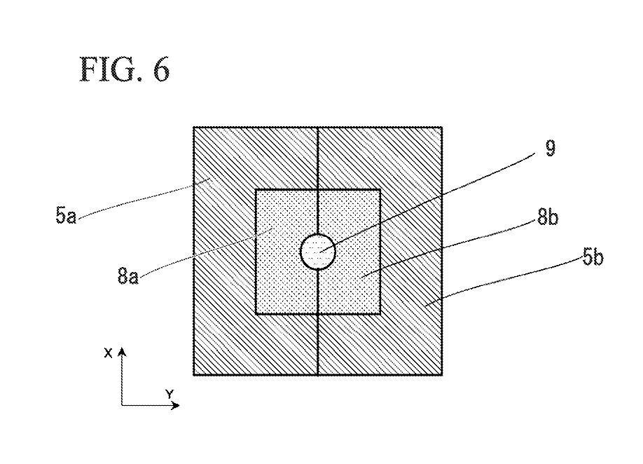

In addition, instead of the plate-shaped wiring 3, wiring having a round shape in the cross section thereof such as a cable may be arranged in the through hole 1 of the H-shaped steel 2. In a case where a fixed member having a shape different from the plate-shaped wiring 3 like this is fixed at the H-shaped steel 2, for example, an auxiliary plate 8 having substantial rectangular shape of a dimension “L×(2÷3)” in the X direction and a dimension “L×(5÷12)” in the Y direction may be used. After cutting or drilling a hole of a predetermined shape at the auxiliary plate 8, by fitting the auxiliary plate 8 into the first grooves of the blocks 5a and 5b respectively, as shown in FIG. 6 as a modification example of the embodiment, similar to case of the plate-shaped wiring 3, the wiring having a circular or triangular cross section can also be fixed to the H-shaped steel 2 in a sandwiched state by auxiliary plates 8a and 8b. An easily workable and insulating material such as plastic resin, rubber, tree or the like is desirable for the material of an auxiliary plate 8, and the block 5 is an insulating material, thereby conductive material such as metal may be used as the material of the auxiliary plate 8 depending on the design.

The holder of the invention is not limited to the embodiments or the modification example thereof and various modifications are possible as long as they do not deviate from the gist of the invention. For example, the above description is given using the H-shaped steel 2 as the base member and using the plate-shaped wiring 3 as the fixed member, however, the invention is not limited to this and the fixed member may be reliably fixed at the base member in a state where the fixed member passes through the through hole of the base member so that configuration members of a vehicle or a vessel, configuration members of a kitchen and configuration members of a desk may be the base member. In addition, the invention is not limited to the metal member; nonmetal members such as a string may become the fixed member may be the fixed member. The through hole of the base member is also not limited to the rectangular shape, various shapes such as a circle, a triangle or the like may be possible, and an holder may also have a shape corresponding to the shape of the through hole.

In addition, the shape of the block 5 to be used at least two is not need to be the same each other and for example, a portion that functions as a stopper may be formed at one block 5 and a portion that functions as the stopper may not be formed at the other block 5. Even in such an assembly, when assembling as the holder, the structure which provides the effect described above may be possible.

Furthermore, the material of each block 5 may be a material different from each other as long as they have the insulating property. In addition, the number of the blocks surrounding the fixed member to sandwich the fixed member is not limited to two, and may be two or more, in other words.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A holder comprising:
a first block having a stopper and a first restrained section and being made from the material which have the insulating property;
a second block having a second restrained section and being made from the material which have the insulating property; and
a restraining member,
wherein a fixed member is surrounded to be sandwiched by using the first block and the second block, the first and the second blocks are inserted into a through hole of a base member until the stopper comes into contact with the base member and the blocks are prevented from entering the through hole, and the first restrained section and the second restrained section protruding from the through hole are restrained by the restraining member in order that the fixed member is fixed to the base member.

2. The holder according to claim 1,
wherein the first block and the second block have an outer shape of a substantial U-shape that has an opening and have the same dimensions and the same shapes as each other, and the fixed member is sandwiched at each opening of the first block and the second block.

3. The holder according to claim 2,
wherein the restraining member is a restraining section included in a third block, and
the first block, the second block and the third block have the same dimensions and the same shapes.
